(19) United States
(12) Patent Application Publication
(10) Pub. No.: US 2007/0143085 A1
(43) Pub. Date: Jun. 21, 2007

(54) Healthcare Information Deficiency Management System

(75) Inventor: Thomas J. Kimmel, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/554,103

(22) Filed: Oct. 30, 2006

Related U.S. Application Data
(60) Provisional application No. 60/748,401, filed on Dec. 8, 2005.

(51) Int. Cl. G06G 7/48

(52) U.S. Cl. 703/3

(57) ABSTRACT

A system automatically performs document reanalysis and identifies when a document that has been modified requires reanalysis by a Healthcare Information Management (HIM) analyst, for example. A document deficiency processing system includes an interface for receiving data identifying a document is modified by a page being inserted into the document to produce a modified document. A deficiency processor determines the modified document is a signed document and generates data identifying a document deficiency and a document deficiency type in response to a determination the modified document is a signed document. A task processor automatically assigns a task to be performed by one or more workers to address the identified document deficiency in response to the generation of the data identifying the document deficiency and the document deficiency type.

This is a non-provisional application of provisional application Ser. No. 60/748,401 by T. J. Kimmel filed Dec. 8, 2005.

### FIELD OF THE INVENTION

This invention concerns a system for identifying and managing document deficiencies, including modification and signing of documents in an automated document completion process.

### BACKGROUNG INFORMATION

The HIM (Healthcare Information Management) department in traditional acute-care facilities analyzes patient's records to fully comply with regulatory requirements and also to ensure full and complete reimbursement from insurance companies for services provided to insured patients. Medical Records analysts review patient records to ensure that required documents are present in a patient record, the documents contain required information, and the documents are signed when required. In response to an analyst finding a document is missing or information is missing, or a signature is missing, the analyst creates an indicator indicating a document “deficiency”, identifying what is missing from the patient record and assigning that deficiency to a worker responsible for providing the missing document, information, or signature. Once this analysis process is completed, these deficiencies may be satisfied or “completed” by the responsible parties without the patient record being reviewed again by an analyst.

When a document in a patient record is modified or altered after the record has been analyzed, the modified document may now contain information that was previously missing, thereby satisfying a deficiency previously created by the analyst, or the modified document might now require new deficiencies because the modified document does not contain required information. Additionally, if the document had been signed by a physician, the physician may be required to sign the modified version of the document as well. A system according to invention principles addresses these deficiency management requirements and related problems.

### SUMMARY OF THE INVENTION

A document deficiency processing system includes an automatic document reanalysis function that detects when documents are modified after initial review by an analyst, for example, identifies how the document was modified, automatically creates a signature deficiency and an analysis deficiency indicator for inclusion in a patient record and routes the patient record to a queue to be re-examined by an analyst. A document deficiency processing system includes an interface for receiving data identifying a document is modified by a page being inserted into the document to produce a modified document. A deficiency processor determines the modified document is a signed document and generates data identifying a document deficiency and a document deficiency type in response to a determination the modified document is a signed document. A task processor automatically assigns a task to be performed by one or more workers to address the identified document deficiency in response to the generation of the data identifying the document deficiency and the document deficiency type,

### BRIEF DESCRIPTION OF THE DRAWING

FIG. 1 shows a document processing system involving document deficiency management, according to invention principles.

FIG. 2 shows a flowchart of a document reanalysis process, according to invention principles.

FIG. 3 shows a user interface image menu illustrating a patient record following an initial analysis, according to invention principles.

FIG. 4 shows a user interface image window illustrating document deficiency processing in response to a new version of a document being received in a patient record, according to invention principles,

FIG. 5 shows a user interface image window illustrating a typical patient record that has gone through analysis and contains a signed document, according to invention principles.

FIG. 6 shows a user interface image window illustrating document processing in response to receiving a new version of a document in a patient record that has gone through analysis, according to invention principles.

FIG. 7 shows a user interface image window enabling user selection of Matching Rules determining whether a received document is a new document or an updated document, according to invention principles.

FIG. 8 shows a flowchart of a process for processing a document involving document deficiency management, according to invention principles.

### DETAILED DESCRIPTION OF INVENTION

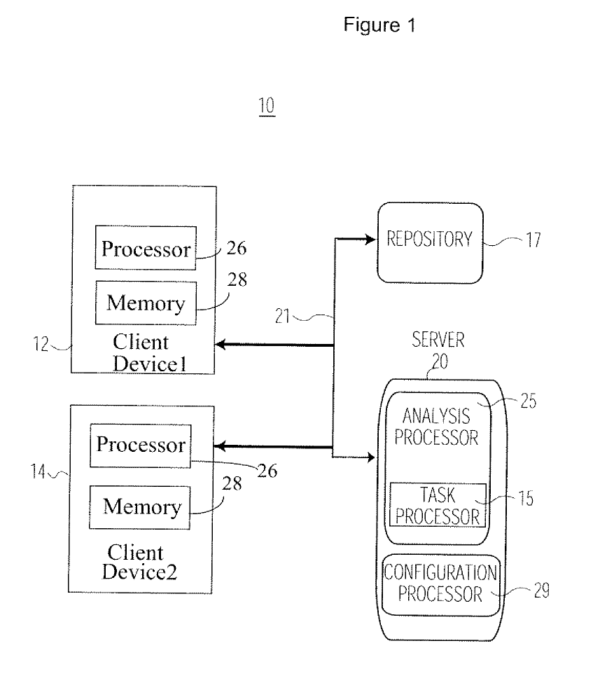

FIG. 1 shows a document processing system 10 involving document deficiency management. The system identities document deficiencies, manages and chains document deficiency indicators together to support workflow control and automates a document completion process. In healthcare it is important to maintain documentation of good quality and this typically involves a review process to ensure that documentation is available and correct. Maintenance of documentation involves monitoring record completion and includes a task sequence workflow to collect documents that are relevant to individual health records and workflows (user or task performed task sequences) to validate that document information is correct and complete and not omitting vital data. The system automatically performs document reanalysis and identifies when a document that has been modified requires reanalysis by a Healthcare Information Management (HIM) analyst, for example. If a signed page of a document is replaced by a new version of that page, a deficiency indicator indicating that a signature is required is automatically created for each signature present on the replaced page of the document. For example, if a two page document has a signature on the second page, replacing the second page causes the system to automatically create a deficiency indicator indicating a signature is required for the second page.

A deficiency indicator identifies that a record is not complete for some reason, such as missing document, missing information on a document, or a required signature is not present in the record. For example, a deficiency indicator is used to indicate that a “history and physical” document is not present in a patient record. After the missing document is acquired into the record, a deficiency can be used to indicate that document needs to be signed by the author. The system is configurable so that in response to a detected modification of a document, a signature deficiency indicator is automatically created for each signature present on the document, regardless of the page modified. In exemplary operation, if a two page document has a signature on the second page, replacing the first pac of the document causes the system to automatically create a deficiency indicator indicating a signature is required for the second page. Further, if a two page document has a signature on the first page, inserting a page into the document (as the third page) causes the system to automatically create a deficiency indicator for the first page, indicating a signature is required.

A record (e.g., a patient medical record) may comprise one or more documents and the term “record” may be used interchangeably with the term “document”. An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks, A processor comprises any one or combination of, hardware, firm-ware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry of software or a combination of both for generating display images or portions thereof. A user interface comprises one or more display images enabling user interaction with a processor or other device. An object or data object as used herein comprises a grouping of data, executable instructions or a combination of both or an executable procedure. A document or record comprises a compilation of data in electronic form and is the equivalent of a paper document and may comprise a single, self-contained unit of information. It may consist of one or more “pares” of information bound together as a unit. The pages may be stored in any digital format as long as the stored pages can be rendered into a human readable presentation. As used herein, inserting a page means to add a new page to a document. Pages may be inserted in the beginning, at the end, or in between existing pages. Insert as used in the claims encompasses adding a new page into a document. Further, replacing a page means to substitute an existing page with a new page.

As used herein the term child refers to a folder or document that is contained within another folder. This term reflects the relationship of a folder or document with the folder in which it is contained. The term complete refers to a condition achieved by a folder or document when the information contained therein is verified to be accurate and whole. In the case of a document, this means when there is no missing information relevant and necessary to the document and the contained information is substantially accurate. A folder is complete when expected or required documents exist for that folder and documents contained in the folder are complete. A deficiency refers to some condition that makes a folder or document incomplete. For example, a folder may be missing an expected or required document or a document may be missing information or contain inaccurate information. A deficiency chain refers to an ordered series of data indicating deficiencies used to define a task sequence (a workflow) performed by a worker or system to control a record completion process. A deficiency chain comprises data indicating a sequence of deficiencies that needs to be addressed in order to ensure that a record or document is complete. A document type (an attribute of a document) is an identifier that is used to group together documents that have the same functional characteristics and allows the logical and physical grouping of documents based on their content. Deficiency types allow deficiencies to have a common set of characteristics based on the fact that they are of the same type. The Automatic Document Reanalysis function of system 10 uses Signature, Miscellaneous Analysis and Analysis deficiency indicators, for example. The Signature deficiency indicator indicates a signature is required, the Miscellaneous Analysis indicator indicates that a document needs to be reviewed and the Analysis indicator indicates that a patient record needs to be analyzed. Document processing system 10 is configurable to perform particular actions based on document type. A Document identifier (document Id) is an internal identifier used to uniquely identify a single document in a document processing system.

A folder is a container used to organize documents. Folders can contain zero or more documents and zero or more subfolders. A folder may be considered a parent of documents and subfolders contained within it. The term incomplete is the antonym of complete. A parent refers to a folder in which another folder or document is contained. This term reflects the relationship of a folder to its contents. The term record is an equivalent term for folder and the two terms may be used interchangeably. Record completion refers to the process required to ensure that a folder or document is complete. A subfolder is a folder that is contained within another folder and is a child of another folder. The invention principles are applicable to any business object (i.e. an object in any industry such as an employee in the human resources industry or an account in the banking industry), but is described for exemplary purposes in the context of business objects of documents and records as defined below.

FIG. 1 shows document processing system 10 including a document deficiency management function. Document processing system 10 includes client devices 12 and 14, repository 17 and server 20. Server 20 includes analysis processor 25 executing a document reanalysis application and configuration processor 29 executing a configuration application. Analysis processor 25 includes task processor 15 executing a task processing (workflow) application. The system 10 devices are interconnected and bidirectionally communicate via network 21 such as a LAN (Local Area Network) or other type of network. A client device 12 or 14 includes processor 26 and memory unit 28 and may comprise a personal computer, for example A user is able create, maintain and manage deficiency chain data using configuration processor 29 via one or more user interface images displayed on client device 12 or 14. The document processing system 10 may be used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Repository 17 (representing one or more distributed repositories) includes chain data identifying, multiple document deficiencies, individual document deficiency type and an order for addressing the document deficiencies for providing completed documents. The document deficiency type and order for addressing the document deficiencies are used by task processor 15 to initiate a method of addressing a deficient condition. Task processor 15 executing a task processing application operating on server 20, uses repository 17 in automatically assigning tasks to be performed by one or more workers in the order for addressing the document deficiencies to correct the deficiencies. A record and the documents contained therein are considered potentially deficient until reviewed by qualified personnel for accuracy and completion. A record or document may be deficient because it is missing vital documents such as an operative report or discharge instructions, it is missing vital information or it contains incorrect information.

Analysis processor 25 provides document auto-analysis and automatically completes, creates and assigns deficiencies on documents in response to incorporation of a document into a patient record based on the type of the document and a predefined set of rules. Analysis processor 25 enables Healthcare Information Management (HIM) departments to automatically identify records that need to be reviewed again, and filters and excludes records that do not need to be re-reviewed as a result of inserting a document into a patient record. Analysis processor 25 automatically creates a deficiency indicator (A Miscellaneous Analysis deficiency indicator) for a patient record indicating that the record needs to be reanalyzed because a specific page was inserted or replaced in a particular document in the record. Analysis processor 25 detects when documents are modified after initial review (e.g., by an HIM analyst), identifies how the document was modified and automatically creates signature deficiencies when needed and creates an analysis deficiency for the patient record. Analysis processor 25 also routes the patient record into a queue to be reanalyzed. Analysis processor 25 ensures that documents of a given type are analyzed regardless of what record they are stored in and increases flexibility in a HIM department analyzing different types of documents. Analysis processor 25 uses configuration settings for a document type set by a user via display images on client device 12 or 14.

HIM departments in health care provider organizations are responsible for ensuring that patient records are complete. However, a HIM department cannot control when documents in a patient record are modified after an initial analysis by the HIM department. A new version of the document may be automatically electronically transmitted from another computer system or a user can insert and/or replace pages in the document using a scanner. The system 10 Automatic Document Reanalysis function improves the accuracy of the information in a patient record by identifying documents that require reanalysis and automatically creating signature and analysis deficiencies where appropriate. This improves regulatory compliance, reduces the number of claims rejected by medical insurance companies due to missing information and helps insure that a facility submits insurance claims for care provided to the patient.

Known systems provide workflows to automate the analysis and processing of deficiencies for patient records but these systems do not detect when documents are modified after analysis and they do not automatically create deficiencies for the document and record. Known systems also do not detect when a new version of a document is electronically received after a document has been analyzed (e.g., by a HIM department) and typically rely on action by a user to indicate that a document has been modified after it has been analyzed. In known systems, if a user does not manually route the document to a HIM department, the patient record and the modified document are not reanalyzed and known systems fail to automatically create signature deficiencies on the document.

When a document is acquired into a patient record, system 10 automatically completes deficiencies in the record that were created as a result of the document not being in the record and applies remaining deficiencies in a deficiency chain if any, to the document that was just acquired. System 10 uses matching logic based on the type of document being acquired. For instance, if a patient record is deemed incomplete because of absence of a “medical history and physical”document, upon acquisition of a “medical history and physical” document, system 10 completes any applicable deficiencies in the record associated with absence of the “medical history and physical” document.

System TO auto-analyzes documents based on document type. This enables a HIM department to configure a document completion function to perform different actions depending on the type of a given document. For instance, a “medical history and physical” document needs to be present in an inpatient medical record and also needs to be signed by an attending physician, while a “progress notes” document needs to be present in the record, but not signed. System 10 ensures that any “medical history and physical” document in the system gets signed. Deficiency types allow deficiencies to have a common set of characteristics based on the fact that they are of the same type. A deficiency type is composed of attributes including, Name, Description, Icon, Process Type and Age.

A Name attribute is indicative of what is deficient in a record. For instance “Wailing” indicates that the record is waiting for something in order to be complete. In this case the record is waiting for a document. A Description type attribute allows for a more complete description of what the deficiency type is supposed to indicate. For instance, “Waiting for missing document” is an appropriate description for a “Waiting” deficiency type. An Icon attribute is used to provide a visual clue to users of a HIM system that a deficiency of a given type is present by just glancing at the record. A Process TFype attribute indicates deficiencies that need to be completed when a document is acquired into a record, or deficiencies that need to be applied to the document that has been acquired. One model process type is “Waiting for Document”, for example. An Age attribute indicates if a deficiency should age or not. This is used to indicate a user, responsible for completing a deficiency, has a given time duration to complete a deficiency. A combination of the above attributes indicates in system 10 how a deficiency that is present in a record or document is to he addressed.

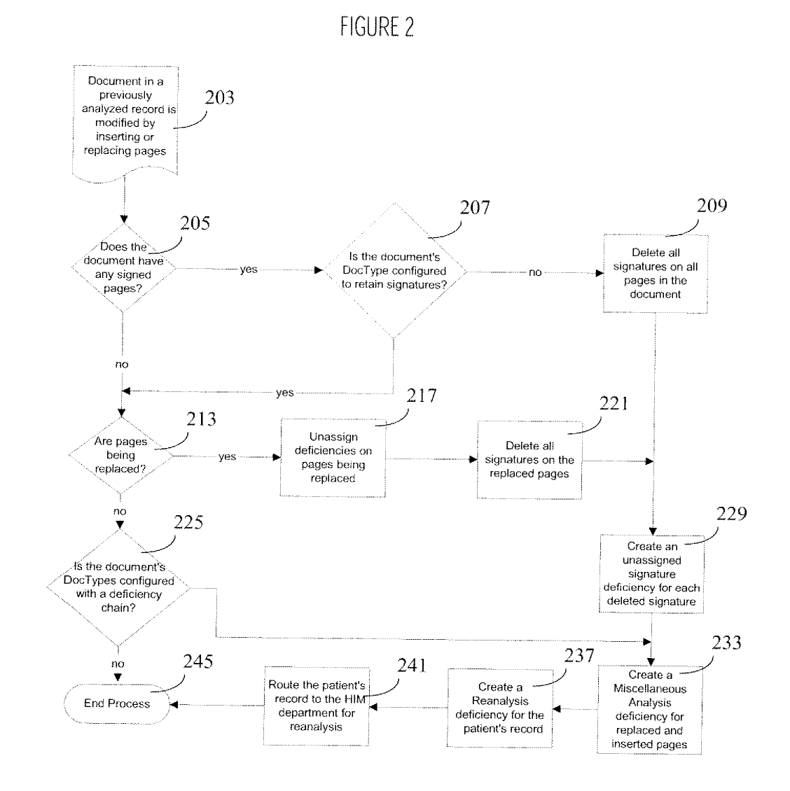

FIG. 2 shows a flowchart of a document reanalysis process performed by system 10. In response to a document being incorporated in a patient record previously analyzed by n Analyst in step 203, Analysis processor 25 in step 205 determines if the document has any signed pages. If the document is determined to have signed pages, analysis processor 25 in step 207, determines whether a document type attribute of the document is configured to indicate signatures are to be retained for the document. If the document type attribute indicates signatures are not to he retained for the document, analysis processor 25 deletes the signatures in the document in step 209 and creates an unassigned signature deficiency record for each deleted signature in step 229. In step 233, analysis processor 25 creates a miscellaneous deficiency record for replaced pages and inserted pages in the document and in step 237, creates a reanalysis deficiency record for the patient record. Analysis processor 25 routes the patient record to a HIM department for reanalysis in step 241 and the process terminates in step 245.

If the document is determined to have no signed pages in step 205 or the document type attribute indicates signatures are to be retained for the document in step 207, analysis processor 25 determines in step 213 whether any document pages are being replaced. In step 217, analysis processor 25 unassigns deficiencies on document pages being replaced and in step 221 deletes signatures on the replaced pages and performs previously described steps 229, 233, 237, 241 and 245. In response to a determination that no page is being replaced in step 213, analysis processor 25 in step 225 determines if the document type attribute indicates a deficiency chain is associated with the document and if so performs previously described steps 233, 237, 241 and 245. If the document type attribute indicates a deficiency chain is not associated with the document, the process terminates in step 245.

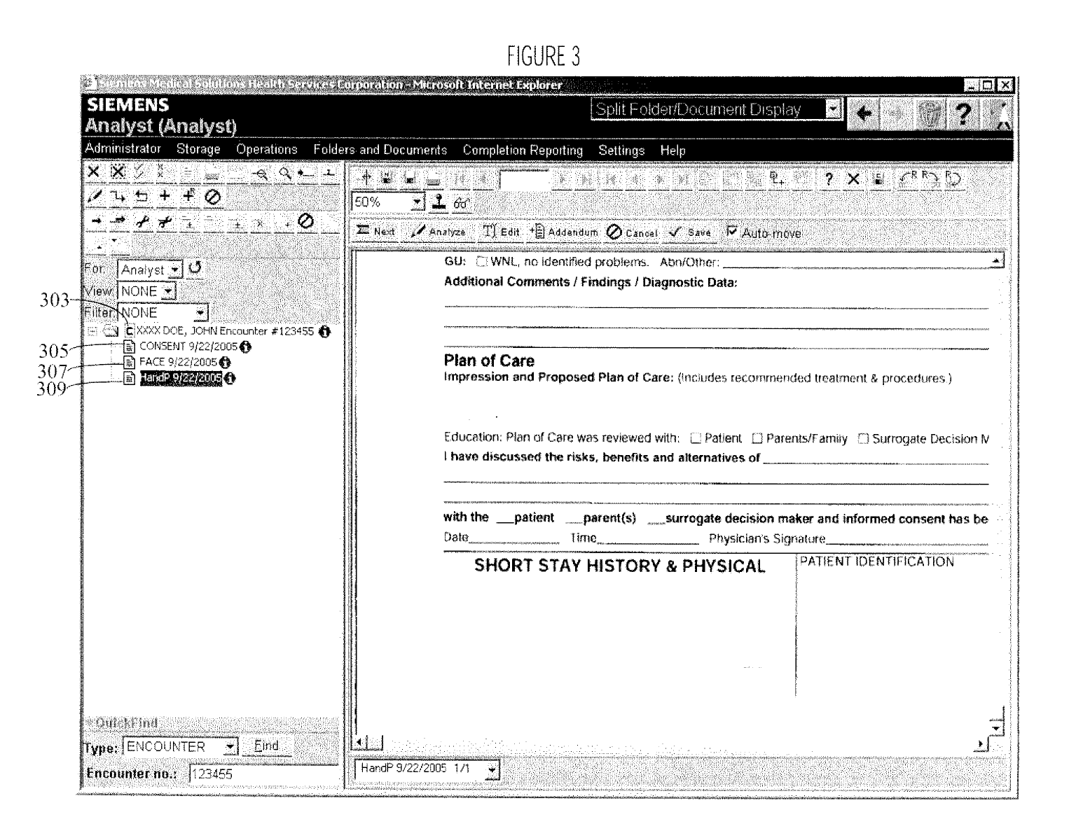

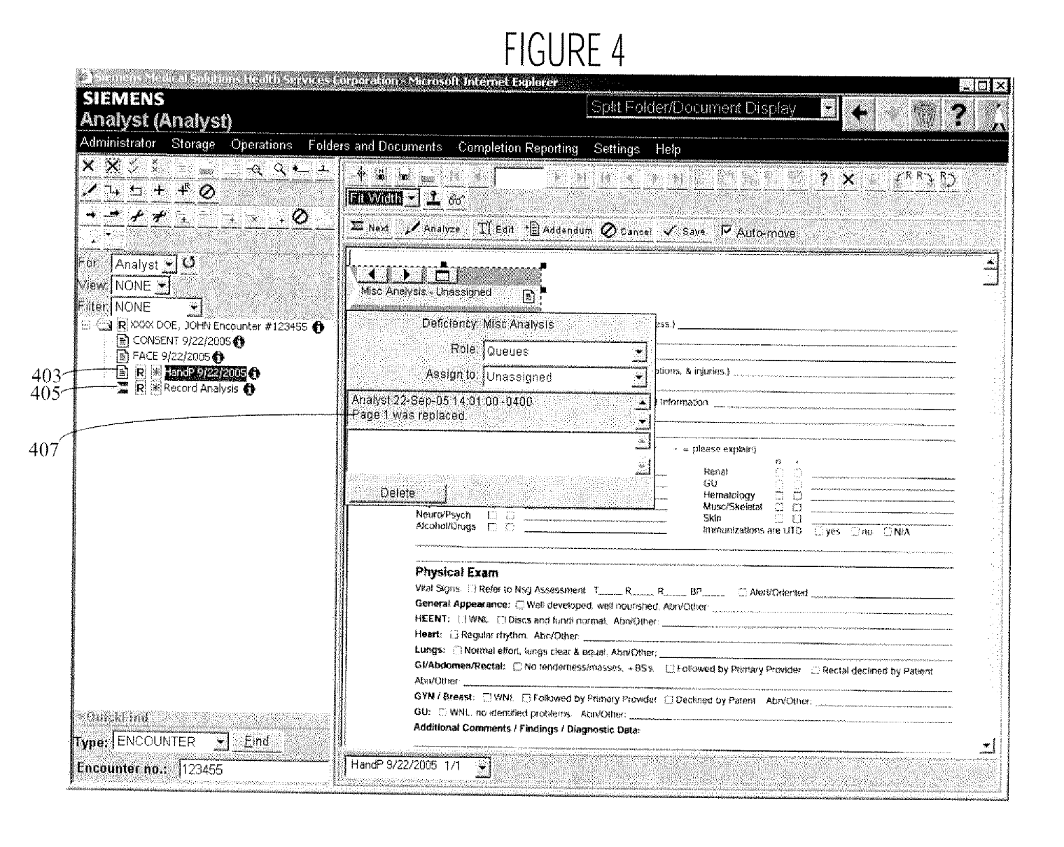

The Automatic Document Reanalysis function in analysis processor 2-5 is initiated when a document is modified after a patient record has been examined for deficiencies. Analysis processor 25 automatically routes a patient record to a HIM department for reanalysis whenever a page is inserted into, or replaced in, a document associated with a deficiency chain. FIG. 3 shows a user interface image menu illustrating a patient record following an initial analysis and in which deficiencies have been completed. The patient record, or folder, includes consent document 305, a patient face related document 307 and a History and Physical (HandP) document 309 and has a status of Complete (shown by the C icon 303 to the left of the folder). FIG. 4 shows a user interface image window illustrating document deficiency processing in response to a new version of a document being received in a patient record. Specifically, a new version of the HandP document is received. The FIG. 4 image indicates status of the patient record (row 405) is “Reanalysis” (indicated by the “s” icon) meaning the patient record has been routed to the HIM department for reanalysis, An Analysis deficiency identified in row 405 (adjacent to the row 405 R icon) has been created, indicating that a HIM analyst needs to reanalyze the patient record. A Miscellaneous Analysis deficiency identified in row 403 (adjacent to the row 403 R icon) has been created on the modified HandP document. The note 407 in the Miscellaneous Analysis deficiency for the HandP document informs an analyst that page 1 was replaced in the document.

In an HIM environment, documents tend to be signed in two ways. In a first way, a signature on the document applies to the entire document. For example, a multi-page document requires signatures from two physicians and each physician signs the document once. When this type of document is modified by inserting or replacing pages, both signatures are deleted and each physician re-signs the document. In a second way, a signature applies to the page that is signed. For example, doctors orders for treatments for different patients may be stored in a HIM system as a single document but each page of that document may be for a different patient. In this case, each page is signed by the attending physician for that patient. If a single pave in this document is replaced, the signatures on tile replaced page are deleted, thereby forcing each doctor to re-sign the document, even though the information being attested to may be unchanged. Preferably only signatures on a page being replaced are deleted.

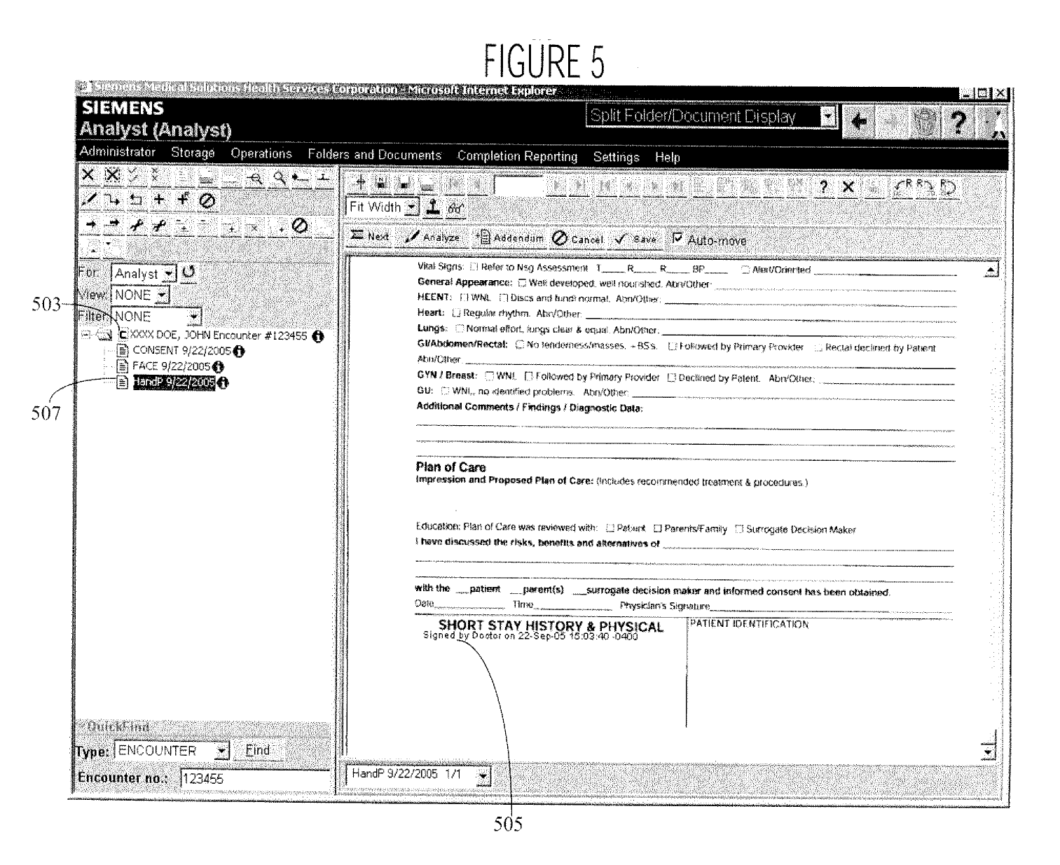

System 10 automates creation of signature deficiencies when replacing signed pages in a document (for documents signed the first way described above). In another embodiment, system 10 is configured to automatically replace signatures in a document with signature deficiencies (for documents signed the second way described above). FIG. 5 shows a user interface image window illustrating a typical patient record that has an analysis status of Complete (shown by the C icon 503 to the left of the folder) and contains a signed document. Specifically, the signed document is a HandP document 507 with an electronic signature 505.

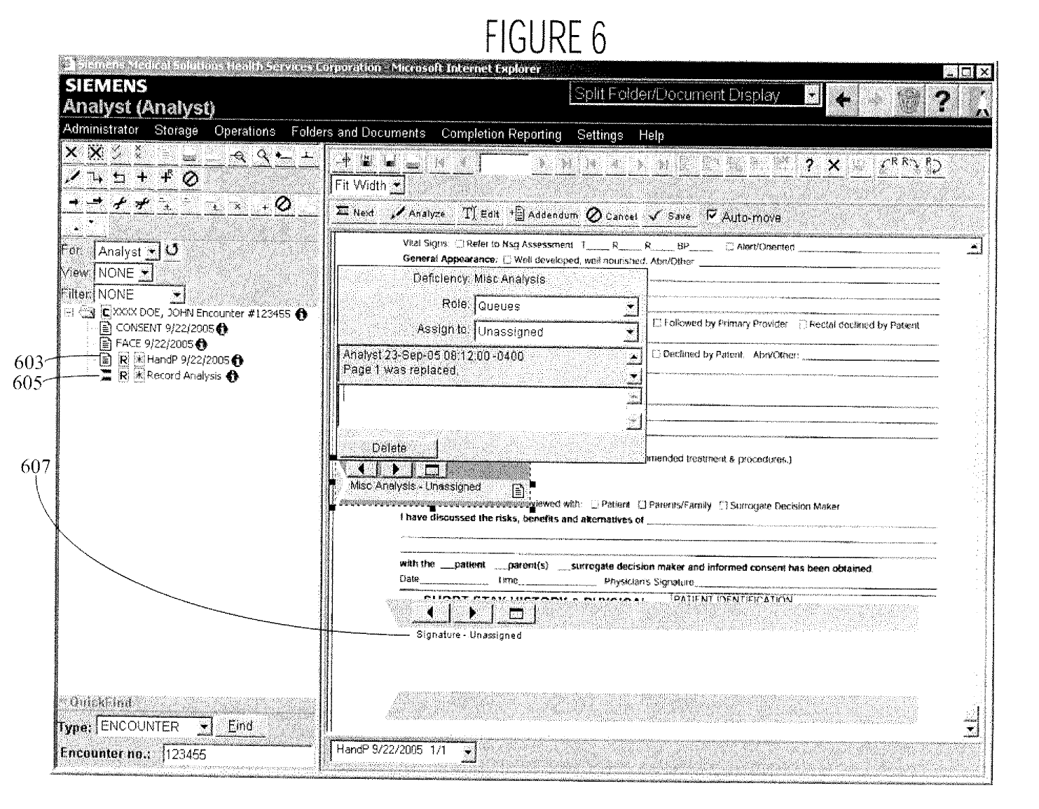

FIG. 6 shows a user interface image window illustrating document processing in response to receiving a new version of a document in a patient record that has gone through analysis. As, with the case of replacing the unsigned HandP document as illustrated in FIG. 4, the patient record or folder is sent to a HIM department for reanalysis. The FIG. 6 image indicates status of the patient record (row 605) is “Reanalysis” (indicated by the “R” icon) meaning the patient record has been routed to the HIM department for reanalysis. An Analysis deficiency identified in row 605 (adjacent to the row 405 R icon) has been created, indicating that a HIM analyst needs to reanalyze the patient record. A Miscellaneous Analysis deficiency identified in row 603 (adjacent to the row 603 R icon) has been created on the modified HandP document. In addition, an unassigned Signature deficiency is also created by analysis processor 25 because the replaced page was signed. Analysis processor 25 automatically creates the unassigned signature deficiency to advantageously reduce the likelihood that an analyst fails to realize the document needs to be signed.

System 10 is applicable in any field that has workflow requirements involving identifying when a document has been modified. Analysis processor 25 employs an Automatic Document Reanalysis function to improve workflows by automatically sending patient records containing modified documents back to a HIM department, for example, for review. Existing documents may be modified either by a user or in response to electronically receiving a modification to a document. Upon storing electronically received documents, a user specifies if a new document is being created or if one or more pages is being inserted or replaced in an existing document. In order to process received electronically transferred documents, matching rules are defined employing criteria used to determine if a new document or an updated document is being received.

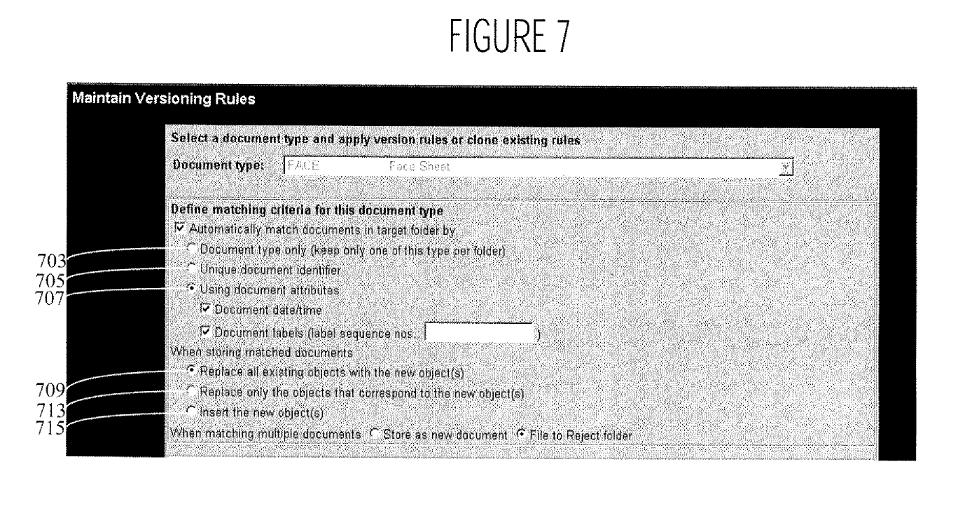

FIG. 7 shows a user interface image window enabling user selection of Matching Rules determining whether a received document is a new document or an updated document. When a document is matched, new pages being stored are considered to be updates to the existing document instead of a new document. The rules are defined based on Document Type. The rules ma,y indicate document matching is based only on a Document Type attribute 703 and there is one document of this type per patient record or folder. The rules may also indicate document matching is based on a Unique Document Identifier 705 and another system is able to provide a document ID to be used for matching. The rules may further indicate document matching is based on document attributes 707 (including document creation or modification date or time and/or document labels). Specifically, the document date/time and/or document labels are used for matching. A document label is a text string that can be extracted from a specific location on a document. For example, an Operation Report might have the procedure type defined as its label. System 10 is directed to store matched documents by replacing existing objects with new objects 709, replacing objects only with corresponding objects 713 or by inserting new objects 715.

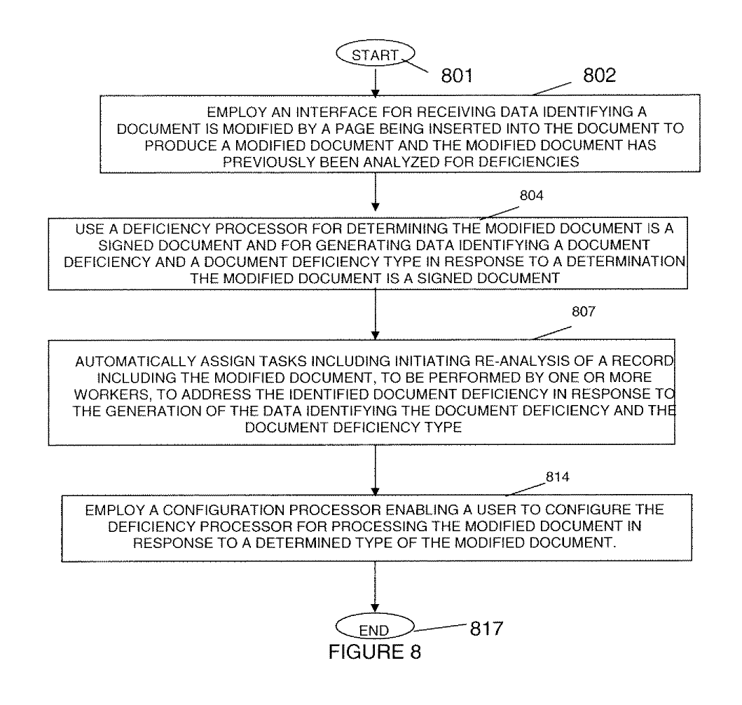

FIG. 8 shows a flowchart of a process employed by system 10 for processing a document involving document deficiency management. In step 802 following the start at step 801 an interface in analysis processor 25 receives data identifying a document is modified by a page being inserted into the document to produce a modified document and the modified document has previously been analyzed for deficiencies. In step 804 a deficiency processor in analysis processor 25 determines the modified document is a signed document (or document portion e.g., the inserted page) and generates data identifying a document deficiency and a document deficiency type in response to a determination the modified document, or document portion, is a signed document or document portion. In one embodiment, the generated data identifies a particular document and the document deficiency type is a signature deficiency requiring signatures to be obtained from one or more people, for example. The page being inserted into the document is inserted by, adding a new page to a document or substituting a new page for an existing page in a document and the deficiency type indicates, how a deficiency is to be corrected and the purpose of the deficiency, for example.

Task processor 15 in step 807 automatically assigns tasks including initiating reanalysis of a record including the modified document, to be performed by one or more workers to address the identified document deficiency in response to the (generation of the data identifying the document, or document portion, deficiency and the document deficiency type. Task processor 15 assigns a task by communicating a message, to a worker alerting the worker to perform a particular action or to a system used for scheduling worker tasks to be performed and accessed by the worker following login to the system. In one embodiment the document is a record in a patient electronic medical record and repository 17 includes chain data (e.g. comprising a data object) identifying, multiple patient medical record document deficiencies, individual patient medical record document deficiency type and an order for addressing the patient medical record document deficiencies for providing completed documents. Repository 17 associates the deficiency type with a process to be used by task processor 15 in assigning tasks in a particular order for correcting the identified document deficiency for the modified document in the order for addressing the document deficiencies. The order for addressing the document deficiencies in the chain data indicates a particular second document deficiency to be corrected subsequent to correction of a first document deficiency. Configuration processor 29 in step 814 enables a user to configure the deficiency processor for processing the modified document in response to a determined type of the modified document. The process of FIG. 8 terminates at step 817.

The system and processes presented in FIGS. 1-8 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system according to invention principles is applicable in any field for monitoring records including one or more documents to ensure the records are maintained to predetermined requirements and reanalyzed in response to changes to previously signed portions of a document. Further, any of the functions and steps provided in the system of FIG. 1 or processes of FIGS. 2 and 8 may be automatically implemented in hardware, software or a combination of both and may reside on one or more processing devices located at any location of a network linking the FIG. 1 elements or another linked network including another intra-net or the Internet.

What is claimed is:

1. A document deficiency processing system, comprising
an interface for receiving data identifying a document is modified by a page being, inserted into said document to produce a modified document:
a deficiency processor for determining said modified document is a signed document and for generating data identifying a document deficiency and a document deficiency type in response to a determination said modified document is a signed document; and
a task processor for automatically assigning a task to be performed by one or more workers to address said identified document deficiency in response to said generation of said data identifying said document deficiency and said document deficiency type.

2. A system according to claim 1, wherein
said deficiency processor determines said page being inserted into said document is associated with a signed portion of said modified document and generates data identifying a deficiency and a document deficiency type of said signed portion of said modified document and
said task processor automatically assigns a task to be performed by one or more workers to address said identified document deficiency of said signed portion of said modified document.

3. A system according to claim 2, wherein
said signed portion of said modified document comprises said page being inserted into said document.

4. A system according to claim 1, wherein
said generated data identifies a particular document and said document deficiency type is a signature deficiency requiring signatures to be obtained from one or more people.

5. A system according to claim 1, wherein
said document has previously been analyzed for deficiencies and
said task to be performed by one or more workers to address said identified document deficiency comprises an automatically initiated reanalysis of said modified document or a record including said modified document.

6. A system,m according to claim 1, wherein
said page being inserted into said document is inserted by at least one of, (a) adding a new page to a document and (b) substituting a new page for an existing page in a document and
said deficiency type indicates at least one of, (i) how a deficiency is to be corrected and (ii) the purpose of the deficiency.

7. A system according to claim 1, wherein
said document is a record in a patient electronic medical record and including
at least one repository including chain data identifying, a plurality of patient medical record document deficiencies, individual patient medical record document deficiency type and an order for addressing said patient medical record document deficiencies for providing completed documents.

8. A system according to claim 7, wherein
said at least one repository associates said deficiency type with a process to he used by said task processor in correcting said identified document deficiency for said modified document in said order for addressing said document deficiencies.

9. A system according to claim 8, wherein
said order for addressing said document deficiencies in said chain data indicates a particular second document deficiency to be corrected subsequent to correction of a first document deficiency.

10. A system according to claim 7, wherein
said chain data comprises a data object.

11. A system according to claim 7, wherein
said task processor assigns tasks in a particular order for addressing said document deficiencies to correct said deficiencies.

12. A system according to claim 1 including
a configuration processor enabling a user to configure said deficiency processor for procession said modified document in response to a determined type of said modified document.

13. A system according to claim 1, wherein
said task processor assigns a task by communicating a message to a worker alerting said worker to perform a particular action.

14. A system according to claim 1, wherein
said task processor assigns a task by communicating a message to a system used for scheduling worker tasks to be performed and accessed by said worker following login to said system.

15. A document deficiency processing system, comprising:
an interface for receiving data identifying a document is modified by a page being inserted into said document to produce a modified document and said modified document has previously been analyzed for deficiencies;
a deficiency processor for determining said modified document is a signed document and for generating data identifying a document deficiency and a document deficiency type in response to a determination said modified document is a signed document; and
a task processor for automatically assigning a task to initiate reanalysis of a record including said modified document, to be performed by one or more workers, by communicating a message to a system used for scheduling worker tasks to be performed.

16. A system according to claim 15, wherein
said task processor assigns a task by communicating a message to a system used for scheduling worker tasks to be performed and accessed by said worker following login, to said system.
